(19) United States
(12) Patent Application Publication
(10) Pub. No.: US 2022/0320530 A1
(43) Pub. Date: Oct. 6, 2022

(54) POROUS BODY, FUEL CELL INCLUDING THE SAME, AND STEAM ELECTROLYSIS APPARATUS INCLUDING THE SAME

(71) Applicant: SUMITOMO ELECTRIC INDUSTRIES, LTD., Osaka-shi, Osaka (JP)

(72) Inventors: Koma NUMATA, Osaka-shi (JP); Masatoshi MAJIMA, Osaka-shi (JP); Mitsuyasu OGAWA, Osaka-shi (JP); Yohei NODA, Osaka-shi (JP)

(73) Assignee: SUMITOMO ELECTRIC INDUSTRIES, LTD., Osaka-shi, Osaka (JP)

(21) Appl. No.: 17/608,949

(22) PCT Filed: Apr. 15, 2020
(86) PCT No.: PCT/JP2020/016535

§ 371 Date: Nov. 4, 2021

(30) Foreign Application Priority Data
May 22, 2019 (JP) 2019-096106

(51) Int. Cl. H01M 8/0232; C01G 51/04; C01G 53/04

(52) U.S. Cl. CPC H01M 8/0232; C01G 51/04; C01G 53/04; C01P 2002/32; C01P 2006/40; C25B 1/042

(57) ABSTRACT

A porous body comprises a framework having a three-dimensional network structure, the framework having a body including nickel and cobalt as constituent elements, the body of the framework including the cobalt at a proportion in mass of 0.2 or more and 0.8 or less relative to a total mass of the nickel and the cobalt, the framework having a surface with an arithmetic mean roughness of 0.05 μm or more, the porous body being increased in volume by 1% or more for a shape of an external appearance thereof after the porous body undergoes a heat treatment in the atmosphere at 800° C. for 200 hours with a load of 16 kPa applied.

### TECHNICAL FIELD

The present disclosure relates to a porous body, a fuel cell including the same, and a steam electrolysis apparatus including the same. The present application claims priority based on Japanese Patent Application No. 2019-096106 filed on May 22, 2019. The disclosure in the Japanese patent application is entirely incorporated herein by reference.

### BACKGROUND ART

Conventionally, porous bodies such as porous metal bodies have a high porosity and hence a large surface area, and thus have been used in various applications such as battery electrodes, catalyst carriers, metal composite materials, and filters.

### CITATION LIST

### Patent Literature

PTL 1: Japanese Patent Laying-Open No. 2012-132083
PTL 2: Japanese Patent Laying-Open No. 2012-149282

### SUMMARY OF INVENTION

A porous body according to one aspect of the present disclosure comprises a framework having a three-dimensional network structure,

the framework having a body including nickel and cobalt as constituent elements,

the body of the framework including the cobalt at a proportion in mass of 0.2 or more and 0.8 or less relative to a total mass of the nickel and the cobalt,

the framework having a surface with an arithmetic mean roughness of 0.05 μm or more,

the porous body being increased in volume by 1% or more for a shape of an external appearance thereof after the porous body undergoes a heat treatment in the atmosphere at 800° C. for 200 hours with a load of 16 kPa applied.

A fuel cell according to one aspect of the present disclosure is a fuel cell including a current collector for an air electrode and a current collector for a hydrogen electrode, at least one of the current collector for the air electrode and the current collector for the hydrogen electrode including the porous body.

A steam electrolysis apparatus according to one aspect of the present disclosure is a steam electrolysis apparatus including a current collector for an air electrode and a current collector for a hydrogen electrode, at least one of the current collector for the air electrode and the current collector for the hydrogen electrode including the porous body.

### BRIEF DESCRIPTION OF DRAWINGS

FIG. 1 is a schematic partial cross section generally showing a partial cross section of a framework of a porous body according to one embodiment of the present disclosure.

FIG. 2 is a cross section taken along a line A-A shown in FIG. 1.

FIG. 3A is an enlarged schematic diagram focusing on one cell in the porous body in order to illustrate a three-dimensional network structure of the porous body according to one embodiment of the present disclosure.

FIG. 3B is a schematic diagram showing an embodiment of a shape of the cell.

FIG. 4A is a schematic diagram showing another embodiment of the shape of the cell.

FIG. 4B is a schematic diagram showing still another embodiment of the shape of the cell.

FIG. 5 is a schematic diagram showing two cells joined together.

FIG. 6 is a schematic diagram showing four cells joined together.

FIG. 7 is a schematic diagram showing one embodiment of a three-dimensional network structure formed by a plurality of cells joined together.

FIG. 8 is a schematic cross section of a fuel cell according to an embodiment of the present disclosure.

FIG. 9 is a schematic cross section of a cell for a fuel cell according to an embodiment of the present disclosure.

FIG. 10 is a graph representing variation in thickness of a sheet-shaped porous body after a predetermined heat treatment is performed.

FIG. 11 is a schematic cross section of a steam electrolysis apparatus according to an embodiment of the present disclosure.

FIG. 12 is a schematic cross section of a cell for the steam electrolysis apparatus according to an embodiment of the present disclosure.

### DETAILED DESCRIPTION

### Problem to be Solved by the Present Disclosure

A variety of such porous metal bodies are known. For example, Japanese Patent Laying-Open No. 2012-132083 (PTL 1) discloses a porous metal body having a framework mainly composed of a nickel-tin alloy as a porous metal body having oxidation resistance and corrosion resistance as characteristics. Japanese Patent Laying-Open No. 2012-149282 (PTL 2) discloses a porous metal body having a framework mainly composed of a nickel-chromium alloy as a porous metal body having high corrosion resistance.

When a porous metal body is used as a current collector for an electrode for a cell, a solid oxide fuel cell (SOFC) (for example, a current collector for an air electrode and a current collector for a hydrogen electrode), in particular, it is exposed to a high environmental temperature of 700 to 1000° C. Therefore, a cell for a fuel cell that is in contact with the current collector for the electrode is thermally deformed, and there may be unsatisfactory contact caused between the porous metal body as the current collector for the electrode and the cell for the fuel cell. This results in the SOFC having a lowered operating voltage. When such thermal deformation of a cell constituting a fuel cell is considered, a porous body such as a porous metal body used as a current collector for an electrode has room for improvement.

The present disclosure has been made in view of the above circumstances, and contemplates a porous body that can maintain satisfactory contact with a cell for a fuel cell when the porous body is used as a current collector for an air electrode or a hydrogen electrode of the fuel cell and the cell for the fuel cell is thermally deformed, a fuel cell including the same, and a steam electrolysis apparatus including the same.

### Advantageous Effect of the Present Disclosure

According to the above, there can be provided a porous body that can maintain satisfactory contact with a cell for a fuel cell when the porous body is used as a current collector for an air electrode or a hydrogen electrode of the fuel cell and the cell for the fuel cell is thermally deformed, a fuel cell including the same, and a steam electrolysis apparatus including the same.

### Description of Embodiments of the Present Disclosure

Initially, embodiments of the present disclosure will be listed and described.

[1] A porous body according to one aspect of the present disclosure comprises a framework having a three-dimensional network structure,

the framework having a body including nickel and cobalt as constituent elements,

the body of the framework including the cobalt at a proportion in mass of 0.2 or more and 0.8 or less relative to a total mass of the nickel and the cobalt,

the framework having a surface with an arithmetic mean roughness of 0.05 μm or more,

the porous body being increased in volume by 1% or more for a shape of an external appearance thereof after the porous body undergoes a heat treatment in the atmosphere at 800° C. for 200 hours with a load of 16 kPa applied.

The porous body having such a feature can maintain satisfactory contact with a cell for a fuel cell when the porous body is used as a current collector for an air electrode or a hydrogen electrode of the fuel cell and the cell for the fuel cell is thermally deformed.

[2] The body of the framework preferably further includes oxygen as a constituent element. This aspect means that the porous body is oxidized as it is used. As the porous body is oxidized, it has a volume increasing for its external shape, and it can thus follow thermal deformation of the cell for the fuel cell and thus maintain satisfactory contact.

[3] The body of the framework preferably includes the oxygen in an amount of 0.1% by mass or more and 35% by mass or less. In that case, contactability, that is, suppression of increase in contact resistance, can more effectively be maintained.

[4] The body of the framework preferably includes a spinel-type oxide. In that case, contactability, that is, suppression of increase in contact resistance, can more effectively be maintained.

[5] Preferably, when the body of the framework is observed in cross section at a magnification of 3,000 times to obtain an observed image, the observed image presents in any area 10 μm square thereof five or less voids each having a longer diameter of 1 μm or more. This allows sufficiently increased strength.

[6] The framework is preferably hollow. This allows the porous body to be lightweight and can also reduce an amount of metal required.

[7] The porous body preferably has a sheet-shaped external appearance and has a thickness of 0.2 mm or more and 2 mm or less. This allows a current collector for an air electrode and a current collector for a hydrogen electrode to be formed to be smaller in thickness than conventional, and can hence reduce an amount of metal required.

[8] A fuel cell according to one aspect of the present disclosure is a fuel cell including a current collector for an air electrode and a current collector for a hydrogen electrode, at least one of the current collector for the air electrode or the current collector for the hydrogen electrode including the porous body. A fuel cell having such a feature can maintain satisfactory contact between a cell for the fuel cell and a current collector for an air electrode or a hydrogen electrode even when the cell for the fuel cell is thermally deformed. The fuel cell can thus efficiently generate power.

[9] A steam electrolysis apparatus according to one aspect of the present disclosure is a steam electrolysis apparatus including a current collector for an air electrode and a current collector for a hydrogen electrode, at least one of the current collector for the air electrode or the current collector for the hydrogen electrode including the porous body. The steam electrolysis apparatus having such a feature allows electrolysis to be done with reduced resistance and steam to be electrolyzed efficiently.

### Detailed Description of Embodiments of the Present Disclosure

Hereinafter, an embodiment of the present disclosure (hereinafter also referred to as “the present embodiment”) will be described. It should be noted, however, that the present embodiment is not exclusive. In the present specification, an expression in the form of “A-B” means a range's upper and lower limits (that is, A or more and B or less), and when A is not accompanied by any unit and B is alone accompanied by a unit, A has the same unit as B.

<<Porous Body>>

A porous body according to the present embodiment is a porous body comprising a framework having a three-dimensional network structure. The framework has a body including nickel and cobalt as constituent elements. The body of the framework includes the cobalt at a proportion in mass of 0.2 or more and 0.8 or less relative to a total mass of the nickel and the cobalt. The framework has a surface with an arithmetic mean roughness of 0.05 μm or more. The porous body is increased in volume by 1% or more for a shape of an external appearance thereof after the porous body undergoes a heat treatment in the atmosphere at 800° C. for 200 hours with a load of 16 kPa applied. The porous body having such a feature can maintain satisfactory contact with a cell for a fuel cell when the porous body is used as a current collector for an air electrode or a hydrogen electrode of the fuel cell and the cell for the fuel cell is thermally deformed (e.g., expanded, warped, and/or the like). Herein, the “porous body” in the present embodiment for example includes a porous body made of a metal, a porous body made of an oxide of the metal, and a porous body including a metal and an oxide of the metal.

When the porous body is used as a current collector for an air electrode of a solid oxide fuel cell (SOFC) and that for a hydrogen electrode thereof and exposed to a high temperature of 700 to 1,000° C., the porous body's framework having a three-dimensional network structure is entirely oxidized. As the porous body is oxidized, it has a volume increasing for its external shape. Accordingly, when the porous body is used as a current collector for an air electrode or a hydrogen electrode of an SOFC, it can follow thermal deformation of the cell for the fuel cell and thus maintain satisfactory contact with the cell for the fuel cell.

When a conventionally known metal mesh or metal nonwoven fabric is used as a current collector for an air electrode or a hydrogen electrode of an SOFC, unsatisfactory contact tends to be caused between the current collector for the air electrode or the hydrogen electrode and the cell for the fuel cell as the cell for the fuel cell is thermally deformed. The metal mesh and the metal nonwoven fabric have many gaps between fibers serving as a constituent unit. Therefore, oxidization of metal only reduces the gaps, and expansion in volume for a shape of an external appearance tends to be difficult to occur.

The porous body in the present embodiment has a plurality of ribs and a plurality of nodes together forming a three-dimensional network structure, as will be described hereinafter. Accordingly, the present inventors consider that as metal is oxidized, expansion in volume for a shape of an external appearance is easily caused.

The porous body can have an external appearance shaped in a variety of forms, such as a sheet, a rectangular parallelepiped, a sphere, and a cylinder. Inter alia, the porous body preferably has a sheet-shaped external appearance and has a thickness of 0.2 mm or more and 2 mm or less. The porous body more preferably has a thickness of 0.5 mm or more and 1 mm or less. The porous body having a thickness of 2 mm or less can be smaller in thickness than conventional, and can thus reduce the amount of metal required. The porous body having a thickness of 0.2 mm or more can have necessary strength. The thickness can be measured for example with a commercially available digital thickness gauge.

The porous body is increased in volume by 1% or more for a shape of an external appearance thereof after the porous body undergoes a heat treatment in the atmosphere at 800° C. for 200 hours with a load of 16 kPa applied. The volume for the shape of the external appearance preferably increases in a range of 1% or more and 20% or less, and more preferably in a range of 2% or more and 10% or less.

A “load of 16 kPa” is applied as follows: That is, initially, a sheet-shaped porous body of 2.5 cm² is prepared as a sample for evaluation. Subsequently, an SUS block (of 1 kg) is placed on a major surface of the sample to apply a load of 16 kPa thereto.

The volume for the shape of the external appearance of the porous body can be determined as follows: For example, when the porous body has a sheet-shaped appearance, a value obtained by multiplying the area of the major surface of the sheet-shaped appearance by the thickness thereof can be used as the volume. When the porous body has a spherical external appearance, a value obtained by multiplying the radius of the spherical appearance to the third power by 4π/3 can be used as the volume.

When the porous body has a sheet-shaped appearance, the porous body is increased in thickness preferably by 1% or more, more preferably in a range of 1% or more and 20% or less, still more preferably in a range of 2% or more and 10% or less, for a shape of an external appearance thereof after the porous body undergoes a heat treatment in the atmosphere at 800° C. for 200 hours with a load of 16 kPa applied. The thickness can be measured for example with a commercially available digital thickness gauge.

<Framework>

The porous body comprises a framework having a three-dimensional network structure, as has been discussed above. The framework has a body including nickel and cobalt as constituent elements. The body of the framework includes the cobalt at a proportion in mass of 0.2 or more and 0.8 or less relative to a total mass of the nickel and the cobalt. The framework has a surface with an arithmetic mean roughness of 0.05 μm or more.

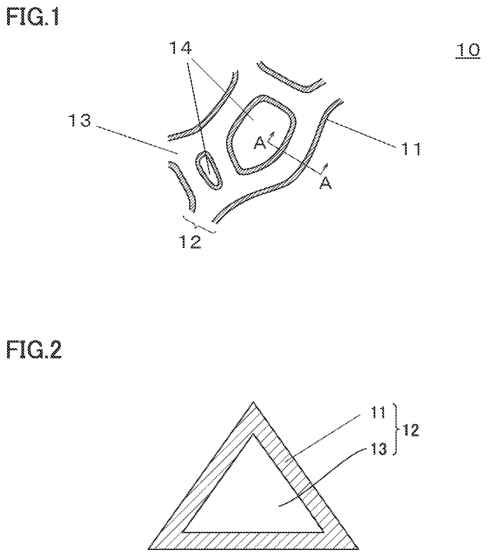

As shown in FIG. 1, the framework has a three-dimensional network structure having a pore 14. The three-dimensional network structure will more specifically be described hereinafter. A framework 12 is composed of a body 11 including nickel and cobalt as constituent elements (hereinafter also referred to as “framework body 11”) and a hollow inner portion 13 surrounded by framework body 11. Framework body 11 forms a rib and a node, as will be described hereinafter. Thus, framework 12 is preferably hollow.

Furthermore, as shown in FIG. 2, framework 12 preferably has a triangular cross section orthogonal to its longitudinal direction. However, the cross section of framework 12 should not be limited thereto. The cross section of framework 12 may be a polygonal cross section other than a triangular cross section, such as a quadrangular or hexagonal cross section. Note that a “triangle” as referred to herein is a concept which is not limited to a geometrical triangle and also includes a substantial triangle. The same applies to other polygons. Furthermore, framework 12 may have a circular cross section.

That is, preferably, framework 12 is such that inner portion 13 surrounded by framework body 11 has a hollow tubular shape, and framework 12 has a triangular or other polygonal, or circular cross section orthogonal to its longitudinal direction. Since framework 12 has a tubular shape, framework body 11 has an inner wall which forms an inner surface of the tube and an outer wall which forms an outer surface of the tube. Framework 12 having framework body 11 surrounding inner portion 13 that is hollow allows the porous body to be significantly lightweight. However, the framework is not limited to being hollow and may instead be solid. In this case, the porous body can be enhanced in strength.

The framework has a surface roughness (or has a surface with an arithmetic mean roughness) of 0.05 μm or more. The surface roughness is preferably 0.05 μm or more and 10 μm or less, more preferably 0.8 μm or more and 5 μm or less. This helps oxidizing the framework and hence increasing volume for a shape for an external appearance of the porous body.

The surface roughness can be measured using a surface roughness meter. In the present embodiment, the surface roughness is measured using a laser microscope (for example, product name: VK-X1000, manufactured by Keyence Corporation) as a surface roughness meter. In doing so, it is measured with a magnification of 1000 times so that at least one rib has a widthwise direction within one field of view. Further, it is measured in a range of any 20 μm-length passing through a center of the rib in the widthwise direction and being parallel to the longitudinal direction of the rib. This measurement is performed for a single porous body at at least 10 fields of view, and an average value of the obtained values is defined as an arithmetic surface roughness Ra of the framework for each sample. The surface roughness means an arithmetic mean roughness Ra as defined in JIS B 0601 (2001).

The framework preferably includes nickel and cobalt such that they have a total apparent weight of 200 g/m² or more and 1,000 g/m² or less. The apparent weight is more preferably 250 g/m² or more and 900 g/m² or less. As will be described hereinafter, the apparent weight can be appropriately adjusted for example when nickel plating is applied on a conductive resin molded body having undergone a conductiveness imparting treatment. For example, when the porous body has an appearance in the form of a sheet, the apparent weight can be determined by the following formula:

apparent weight (g/m²)=M (g)/S (m²)

where M: mass of framework [g], and

S: area of major surface of framework in appearance [m²]

The total apparent weight of nickel and cobalt described above is converted into a mass per unit volume of the framework (or an apparent density of the framework), as follows: That is, the framework has an apparent density preferably of 0.14 g/cm³ or more and 0.75 g/cm³ or less, more preferably 0.18 g/cm³ or more and 0.65 g/cm³ or less. Herein, the “framework's apparent density” is defined by the following expression:

Framework's apparent density (g/cm³)=M (g)/V (cm³),

where M: mass of framework [g], and

V: volume of shape of external appearance of framework [cm³].

The framework has a porosity preferably of 40% or more and 98% or less, more preferably 45% or more and 98% or less, most preferably 50% or more and 98% or less. The framework having a porosity of 40% or more allows the porous body to be significantly lightweight and also have an increased surface area. The framework having a porosity of 98% or less allows the porous body to have sufficient strength.

The framework's porosity is defined by the following expression:

Porosity (%)=[1−{M/(V×d)}]×100,

where M: mass of framework [g],

V: volume of shape of external appearance of framework [cm³], and

d: density of metal constituting framework [g/cm³].

The framework preferably has an average pore diameter of 60 μm or more and 3,500 μm or less. The framework having an average pore diameter of 60 μm or more can enhance the porous body in strength. The framework having an average pore diameter of 3,500 μm or less can enhance the porous body in bendability (or bending workability). From these viewpoints, the framework has an average pore diameter more preferably of 80 μm or more and 1,000 μm or less, most preferably 100 μm or more and 850 μm or less.

The framework's average pore diameter can be determined in the following method: That is, initially, a microscope is used to observe a surface of the framework at a magnification of 3,000 times to obtain an observed image and at least 10 fields of view thereof are prepared, and subsequently, in each of the 10 fields of view, the number of pores is determined per 1 inch (25.4 mm=25,400 μm) of a cell, which will be described hereinafter. Furthermore, the numbers of pores in these 10 fields of view are averaged to obtain an average value (n_{c}) which is in turn substituted into the following expression to calculate a numerical value, which is defined as the framework's average pore diameter:

Average pore diameter (μm)=25,400 μm/n_{c}.

Note that herein the framework's porosity and average pore diameter are the same as the porous body's porosity and average pore diameter.

Preferably, when the body of the framework is observed in cross section at a magnification of 3,000 times to obtain an observed image, the observed image presents in any area 10 μm square thereof five or less voids each having a longer diameter of 1 μm or more. The number of voids is more preferably 3 or less. The porous body can thus sufficiently be enhanced in strength. Furthermore, it is understood that as the number of voids is 5 or less, the body of the framework is different from a formed body obtained by sintering fine powder. The lower limit of the number of voids observed is, for example, zero. Herein, the “number of voids” means an average in number of voids determined by observing each of a plurality of (e.g., 10) “areas 10 μm square” in a cross section of the framework body.

The framework body can be observed in cross section by using an electron microscope. Specifically, it is preferable to obtain the “number of voids” by observing a cross section of the framework body in 10 fields of view. The cross section of the framework body may be a cross section orthogonal to the longitudinal direction of the framework or may be a cross section parallel to the longitudinal direction of the framework. In the observed image, a void can be distinguished from other parts by contrast in color (or difference in brightness). While the upper limit of the longer diameter of the void should not be limited, it is for example 10,000 μm.

The framework body preferably has an average thickness of 10 μm or more and 50 μm or less. Herein, “the framework body's thickness” means a shortest distance from an inner wall, or an interface with the hollow of the inner portion, of the framework to an outer wall located on an external side of the framework, and an average value thereof is defined as “the framework body's average thickness.” The framework body's thickness can be determined by observing a cross section of the framework with an electron microscope.

Specifically, the framework body's average thickness can be determined in the following method: Initially, a sheet-shaped porous body is cut to expose a cross section of the framework body. One cross section cut is selected, and enlarged with an electron microscope at a magnification of 3,000 times and thus observed to obtain an observed image. Subsequently, a thickness of any one side of a polygon (e.g., the triangle shown in FIG. 2) forming one framework appearing in the observed image is measured at a center of that side, and defined as the framework body's thickness. Further, such a measurement is done for 10 observed images (or in 10 fields of view of image observed) to obtain the framework body's thickness at 10 points. Finally, the 10 points' average value is calculated to obtain the framework body's average thickness.

(Three-Dimensional Network Structure)

The porous body comprises a framework having a three-dimensional network structure. In the present embodiment, a “three-dimensional network structure” means a structure in the form of a three-dimensional network. The three-dimensional network structure is formed by a framework. Hereinafter, the three-dimensional network structure will more specifically be described.

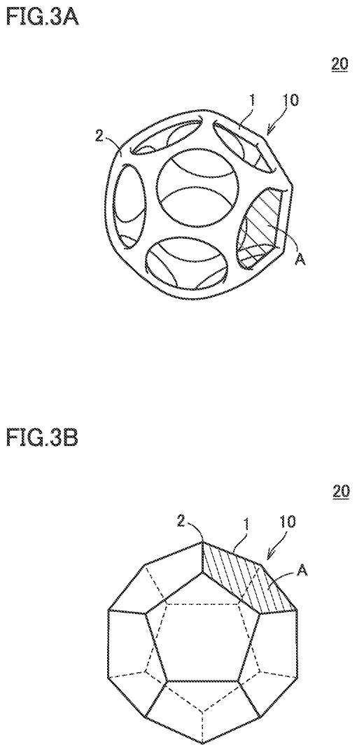

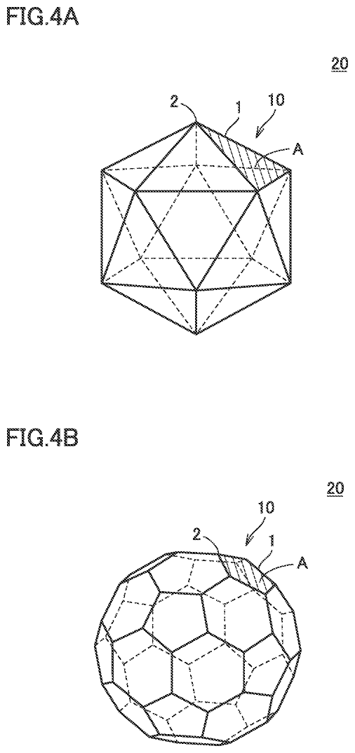

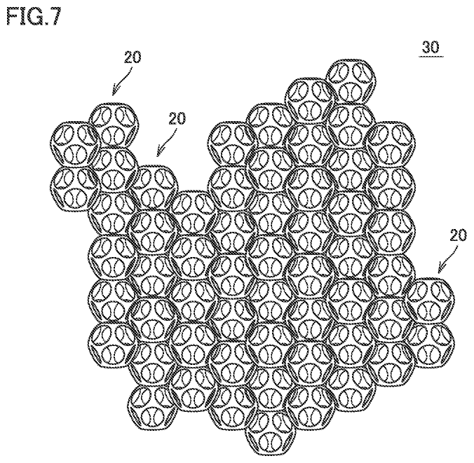

As shown in FIG. 7, a three-dimensional network structure 30 has a cell 20 as a basic unit, and is formed of a plurality of cells 20 joined together. As shown in FIGS. 3A and 3B, cell 20 includes a rib 1 and a node 2 that connects a plurality of ribs 1. Although rib 1 and node 2 are described separately in terminology for the sake of convenience, there is no clear boundary therebetween. That is, a plurality of ribs 1 and a plurality of nodes 2 are integrated together to form cell 20, and cell 20 serves as a constituent unit to form three-dimensional network structure 30. Hereinafter, in order to facilitate understanding, the cell shown in FIG. 3A will be described as the regular dodecahedron shown in FIG. 3B.

Initially, a plurality of ribs 1 and a plurality of nodes 2 are present to form a frame 10 in the form of a planar polygonal structure. While FIG. 3B shows frame 10 having a polygonal structure that is a regular pentagon, frame 10 may be a polygon other than a regular pentagon, such as a triangle, a quadrangle, or a hexagon. Herein, the structure of frame 10 can also be understood such that a plurality of ribs 1 and a plurality of nodes 2 form a planar polygonal aperture. In the present embodiment, the planar polygonal aperture has a diameter, which means a diameter of a circle circumscribing the planar polygonal aperture defined by frame 10. A plurality of frames 10 are combined together to form cell 20 that is a three-dimensional, polyhedral structure. In doing so, one rib 1 and one node 2 are shared by a plurality of frames 10.

As shown in the schematic diagram of FIG. 2 described above, rib 1 preferably has, but is not limited to, a hollow tubular shape and has a triangular cross section. Rib 1 may have a polygonal cross section other than a triangular cross section, such as a quadrangular or hexagonal cross section, or a circular cross section. Node 2 may be shaped to have a vertex to have a sharp edge, the vertex chamfered to have a planar shape, or the vertex rounded to have a curved shape.

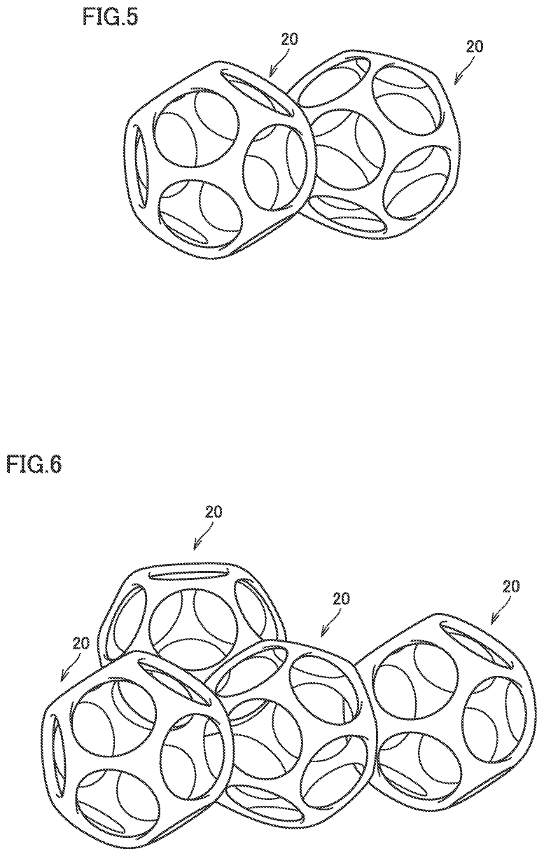

While the polyhedral structure of cell 20 is a dodecahedron in FIG. 3B, it may be other polyhedrons such as a cube, an icosahedron (see FIG. 4A), and a truncated icosahedron (see FIG. 4B). Herein, the structure of cell 20 can also be understood as forming a three-dimensional space (i.e., pore 14) surrounded by a virtual plane A defined by each of a plurality of frame 10. In the present embodiment, it can be understood that the three-dimensional space has a pore with a diameter (hereinafter also referred to as a “pore diameter”) which is a diameter of a sphere circumscribing the three-dimensional space defined by cell 20. Note, however, that in the present embodiment the porous body's pore diameter is calculated based on the above-described calculation formula for the sake of convenience. That is, the diameter of the pore (or the pore diameter) of the three-dimensional space defined by cell 20 refers to what is the same as the framework's porosity and average pore diameter.

A plurality of cells 20 are combined together to form three-dimensional network structure 30 (see FIGS. 5 to 7). In doing so, frame 10 is shared by two cells 20. Three-dimensional network structure 30 can also be understood to include frame 10 and can also be understood to include cell 20.

As has been described above, the porous body has a three-dimensional network structure that forms a planar polygonal aperture (or a frame) and a three-dimensional space (or a cell). Therefore, it can be clearly distinguished from a two-dimensional network structure only having a planar aperture (e.g., a punched metal, a mesh, etc.). Furthermore, the porous body has a plurality of ribs and a plurality of nodes integrally forming a three-dimensional network structure, and can thus be clearly distinguished from a structure such as non-woven fabric formed by intertwining fibers serving as constituent units. The porous body having such a three-dimensional network structure can have continuous pores.

In the present embodiment, the three-dimensional network structure is not limited to the above-described structure. For example, the cell may be formed of a plurality of frames each having a different size and a different planar shape. Furthermore, the three-dimensional network structure may be formed of a plurality of cells each having a different size and a different three-dimensional shape. The three-dimensional network structure may partially include a frame without having a planar polygonal aperture therein or may partially include a cell without having a three-dimensional space therein (or a cell having a solid interior).

(Nickel and Cobalt)

The framework has a body including nickel and cobalt as constituent elements, as has been discussed above. The body of the framework body does not exclude including a third component other than nickel and cobalt unless the third component affects the presently disclosed porous body's function and effect. However, the body of the framework preferably includes the above two components (nickel and cobalt) as a metal component. Specifically, the body of the framework preferably includes a nickel-cobalt alloy composed of nickel and cobalt. In particular, the nickel-cobalt alloy is preferably a major component of the body of the framework. Herein, a “major component” of the body of the framework refers to a component having the largest proportion in mass in the body of the framework. More specifically, when the body of the framework is occupied by a component at a proportion in mass exceeding 50% by mass, the component is referred to as a major component of the body of the framework.

The body of the framework preferably contains nickel and cobalt at a proportion in mass of 80% by mass or more, more preferably 90% by mass or more, most preferably 95% by mass or more in total for example before the porous body is used as a current collector for an air electrode for an SOFC or a current collector for a hydrogen electrode for the SOFC, that is, before the porous body is exposed to a high temperature of 700° C. or higher. The body of the framework may contain nickel and cobalt at a proportion in mass of 100% by mass in total. When the body of the framework contains nickel and cobalt at a proportion in mass of 100% by mass in total, the body of the framework has a composition which can be represented by a chemical formula of Ni₁₋ₛCoₛ, where 0.2≤s≤0.8.

When a porous body comprising a framework having a body containing nickel and cobalt in a larger amount in total is used as a current collector for an air electrode for an SOFC or a current collector for a hydrogen electrode for the SOFC, a proportion of a generated oxide being a spinel-type oxide composed of nickel and/or cobalt and oxygen, tends to increase. Thus, the porous body can maintain high conductivity even when used in a high temperature environment.

(Proportion in Mass of Cobalt Relative to Total Mass of Nickel and Cobalt)

The body of the framework includes cobalt at a proportion in mass of 0.2 or more and 0.8 or less relative to a total mass of nickel and cobalt. Preferably, the body of the framework includes cobalt at a proportion in mass of 0.2 or more and 0.6 or less relative to a total mass of nickel and cobalt. When a porous body comprising a framework having such a composition is used as a current collector for an air electrode or a hydrogen electrode of an SOFC or the like, sufficient strength can be maintained even when the framework is oxidized. Further, a spinel-type oxide represented by a chemical formula of Ni₃₋ₓCoₓO₄, where 0.6≤x≤2.4, typically NiCo₂O₄ or Ni₂CoO₄, is generated in the framework body by oxidation. As the framework body is oxidized, a spinel-type oxide represented by the chemical formula of CoCo₂O₄ may also be generated. The spinel-type oxide exhibits high conductivity, and the porous body can hence maintain high conductivity even when the framework body is entirely oxidized as the porous body is used in a high temperature environment.

(Oxygen)

The body of the framework preferably further includes oxygen as a constituent element. Specifically, the body of the framework more preferably includes oxygen in an amount of 0.1% by mass or more and 35% by mass or less. The oxygen in the framework body can be detected, for example, after the porous body is used as a current collector for an air electrode or a hydrogen electrode of an SOFC. That is, preferably, after the porous body is exposed to a temperature of 700° C. or higher, the body of the framework includes oxygen in an amount of 0.1% by mass or more and 35% by mass or less. More preferably, the body of the framework includes oxygen in an amount of 10% by mass or more and 30% by mass or less, still more preferably 25% by mass or more and 28% by mass or less.

When the body of the framework includes oxygen as a constituent element in an amount of 0.1% by mass or more and 35% by mass or less, a thermal history that the porous body has been exposed to a high temperature of 700° C. or higher can be inferred. Furthermore, when the porous body is used as a current collector for an air electrode or a hydrogen electrode of an SOFC or the like and thus exposed to a high temperature of 700° C. or higher, and a spinel-type oxide composed of nickel and/or cobalt and oxygen is generated in the framework body, the body of the framework tends to include oxygen as a constituent element in an amount of 0.1% by mass or more and 35% by mass or less.

That is, the body of the framework preferably includes a spinel-type oxide. Thus, the porous body can maintain high conductivity more effectively even when it is oxidized. When the body of the framework contains oxygen at a proportion departing the above range, the porous body tends to fail to obtain an ability as desired to maintain high conductivity more effectively when it is oxidized.

(Third Component)

The body of the framework can include a third component as a constituent element insofar as it does not affect a function and effect that the presently disclosed porous body has. The body of the framework may include as the third component for example silicon, magnesium, carbon, tin, aluminum, sodium, iron, tungsten, titanium, phosphorus, boron, silver, gold, chromium, and molybdenum. These components may be included, for example, as unavoidable impurities that are unavoidably introduced in a manufacturing method described hereinafter. For example, examples of unavoidable impurities include elements included in a conductive coating layer formed by a conductiveness imparting treatment described hereinafter. Further, the body of the framework may include oxygen as the third component in a state before the porous body is used as a current collector for an air electrode for an SOFC or a current collector for a hydrogen electrode for the SOFC. The framework body preferably includes the third component individually in an amount of 5% by mass or less, and such third components together in an amount of 10% by mass or less.

The proportion in mass of oxygen contained in the body of the framework (in % by mass) can be determined as follows: an image of a cross section of the framework cut, as observed through a scanning electron microscope (SEM), can be analyzed with an EDX device accompanying the SEM (for example, an SEM part: trade name “SUPRA35VP” manufactured by Carl Zeiss Microscopy Co., Ltd., and an EDX part: trade name “octane super” manufactured by AMETEK, Inc.) to determine the proportion in mass of each element contained in the body of the framework. The EDX device can also be used to determine a proportion in mass of nickel and cobalt in the body of the framework. Specifically, based on the atomic concentration of each element detected by the EDX device, oxygen, nickel and cobalt in % by mass, mass ratio, and the like in the body of the framework can be determined. Further, whether the body of the framework has a spinel-type oxide composed of nickel and/or cobalt and oxygen can be determined by exposing the cross section to an X-ray and analyzing its diffraction pattern, i.e., by X-ray diffractometry (XRD).

For example, whether the body of the framework has a spinel-type oxide can be determined using a measurement device such as an X-ray diffractometer (for example, trade name (model number): “Empyrean” manufactured by Spectris, and analysis software: “integrated X-ray powder diffraction software PDXL”). The measurement may be done for example under the following conditions:

(Measurement Conditions)

X-ray diffractometry: θ-2θ method
Measuring system: collimated beam optical mirror
Scan range (2θ): 10° to 90°
cumulative time: 1 second/step
step: 0.03°.

<<Fuel Cell>>

A fuel cell according to the present embodiment is a fuel cell comprising a current collector for an air electrode and a current collector for a hydrogen electrode. At least one of the current collector for the air electrode and the current collector for the hydrogen electrode includes the porous body. The current collector for the air electrode or the hydrogen electrode includes a porous body that can maintain satisfactory contact with a cell for a fuel cell even when the cell for the fuel cell is thermally deformed (e.g., expanded), as set forth above. The current collector for the air electrode or the current collector for the hydrogen electrode is thus suitable as at least one of a current collector for an air electrode or a hydrogen electrode of an SOFC that attains a high temperature of 700° C. or higher in operation. For the fuel cell, it is more suitable to use the porous body as the current collector for the air electrode as the porous body includes nickel and cobalt.

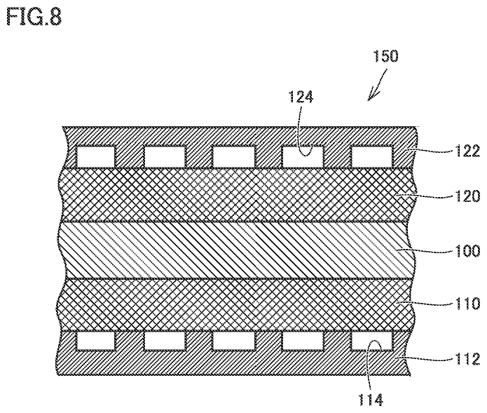

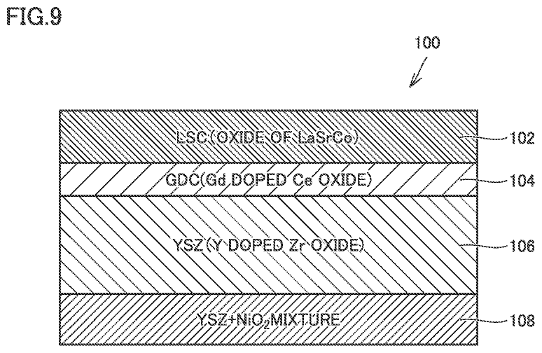

FIG. 8 is a schematic cross section of a fuel cell according to an embodiment of the present disclosure. A fuel cell 150 comprises a current collector 110 for a hydrogen electrode, a current collector 120 for an air electrode, and a cell 100 for the fuel cell. Cell 100 for the fuel cell is provided between current collector 110 for the hydrogen electrode and current collector 120 for the air electrode. Herein a “current collector for a hydrogen electrode” means a current collector on a side in a fuel cell that supplies hydrogen. A “current collector for an air electrode” means a current collector on a side in the fuel cell that supplies a gas (e.g., air) containing oxygen.

FIG. 9 is a schematic cross section of a cell for a fuel cell according to an embodiment of the present disclosure. Cell 100 for the fuel cell includes an air electrode 102, a hydrogen electrode 108, an electrolyte layer 106 provided between air electrode 102 and hydrogen electrode 108, and an intermediate layer 104 provided between electrolyte layer 106 and air electrode 102 to prevent a reaction therebetween. As the air electrode, for example, an oxide of LaSrCo (LSC) is used. As the electrolyte layer, for example, an oxide of Zr doped with Y (YSZ) is used. As the intermediate layer, for example, an oxide of Ce doped with Gd (GDC) is used. As the hydrogen electrode, for example, a mixture of YSZ and NiO₂ is used.

Fuel cell 150 further comprises a first interconnector 112 having a fuel channel 114 and a second interconnector 122 having an oxidant channel 124. Fuel channel 114 is a channel for supplying fuel (for example, hydrogen) to hydrogen electrode 108. Fuel channel 114 is provided on a major surface of first interconnector 112 that faces current collector 110 for the hydrogen electrode. Oxidant channel 124 is a channel for supplying an oxidant (for example, oxygen) to air electrode 102. Oxidant channel 124 is provided on a major surface of second interconnector 122 that faces current collector 120 for the air electrode.

<<Steam Electrolysis Apparatus>>

A steam electrolysis apparatus according to the present embodiment is a steam electrolysis apparatus comprising a current collector for an air electrode and a current collector for a hydrogen electrode and having a structure similar to that of the above fuel cell. At least one of the current collector for the air electrode and the current collector for the hydrogen electrode includes the porous body. The current collector for the air electrode or the current collector for the hydrogen electrode includes a porous body having appropriate strength as a current collector for a steam electrolysis apparatus, as described above. The current collector for the air electrode or the current collector for the hydrogen electrode is thus suitable as at least one of a current collector for an air electrode of a steam electrolysis apparatus or a current collector for a hydrogen electrode of the steam electrolysis apparatus. For the steam electrolysis apparatus, it is more suitable to use the porous body as the current collector for the air electrode as the porous body includes nickel and cobalt, and as one example thereof, resistance and hence electrolytic voltage are effectively reduced.

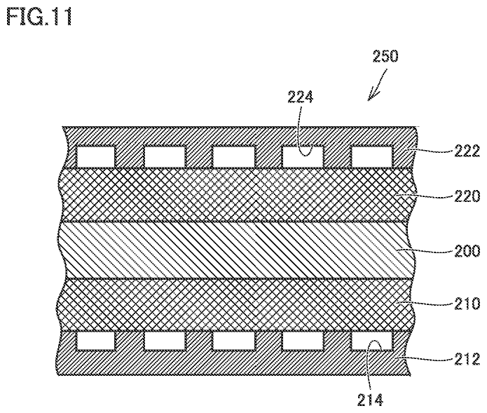

FIG. 11 is a schematic cross section of a steam electrolysis apparatus according to an embodiment of the present disclosure. A steam electrolysis apparatus 250 comprises a current collector 210 for a hydrogen electrode, a current collector 220 for an air electrode, and a cell 200 for the steam electrolysis apparatus. Cell 200 for the steam electrolysis apparatus is provided between current collector 210 for the hydrogen electrode and current collector 220 for the air electrode. Herein a “current collector for a hydrogen electrode” means a current collector on a side in a steam electrolysis apparatus that generates hydrogen. A “current collector for an air electrode” means a current collector on a side in the steam electrolysis apparatus that supplies a steam-containing gas (e.g., humidified air). The current collector for the air electrode can also be understood to be a current collector on a side in a steam electrolysis apparatus that generates oxygen. Furthermore, in one aspect of the present embodiment, the steam-containing gas may be supplied from the side of the current collector for the hydrogen electrode.

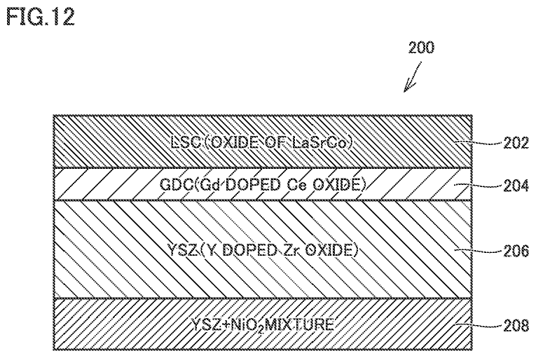

FIG. 12 is a schematic cross section of a cell for the steam electrolysis apparatus according one aspect of the present disclosure. Cell 200 for the steam electrolysis apparatus comprises an air electrode 202, a hydrogen electrode 208, an electrolyte layer 206 provided between air electrode 202 and hydrogen electrode 208, and an intermediate layer 204 provided between electrolyte layer 206 and air electrode 202 to prevent a reaction therebetween. As the air electrode, for example, an oxide of LaSrCo (LSC) is used. As the electrolyte layer, for example, an oxide of Zr doped with Y (YSZ) is used. As the intermediate layer, for example, an oxide of Ce doped with Gd (GDC) is used. As the hydrogen electrode, for example, a mixture of YSZ and NiO₂ is used.

Steam electrolysis apparatus 250 further comprises a first interconnector 212 having a hydrogen channel 214 and a second interconnector 222 having a steam channel 224. Hydrogen channel 214 is a channel for recovering hydrogen from hydrogen electrode 208. Hydrogen channel 214 is provided on a major surface of first interconnector 212 that faces current collector 210 for the hydrogen electrode. Steam channel 224 is a channel for supplying steam (e.g., humidified air) to air electrode 202. Steam channel 224 is provided on a major surface of second interconnector 222 that faces current collector 220 for the air electrode.

<<Method for Producing Porous Body>>

The porous body according to the present embodiment can be produced for example in the following method:

That is, the method is a method for producing a porous body, comprising:

forming a conductive coating layer on a resin molded body having a three-dimensional network structure to obtain a conductive resin molded body (a first step);

plating the conductive resin molded body with nickel to obtain a first porous body precursor (a second step);

plating the first porous body precursor with cobalt to obtain a second porous body precursor (a third step);

applying a heat treatment to the second porous body precursor to incinerate a resin component in the conductive resin molded body and thus remove the resin component to obtain a third porous body precursor (a fourth step); and

applying a heat treatment to the third porous body precursor in a reducing atmosphere to thermally diffuse nickel and cobalt to thus obtain a porous body (a fifth step). A similar porous body can also be produced by performing the second step followed by the fourth step followed by the third step followed by the fifth step.

<First Step>

Initially, a sheet of a resin molded body having a three-dimensional network structure (hereinafter also simply referred to as a “resin molded body”) is prepared. Polyurethane resin, melamine resin, or the like can be used as the resin molded body. Furthermore, as a conductiveness imparting treatment for imparting conductiveness to the resin molded body, a conductive coating layer is formed on a surface of the resin molded body. The conductiveness imparting treatment can for example be the following method:

(1) applying a conductive paint containing carbon, conductive ceramic or similarly conductive particles and a binder to the resin molded body, impregnating the resin molded body with the conductive paint, or the like to include the conductive paint in a surface of the resin molded body;
(2) forming a layer of a conductive metal such as nickel and copper on a surface of the resin molded body by electroless plating; and
(3) forming a layer of a conductive metal on a surface of the resin molded body by vapor deposition or sputtering. A conductive resin molded body can thus be obtained.

<Second Step>

Subsequently, the conductive resin molded body is plated with nickel to obtain the first porous body precursor. While the conductive resin molded body can be plated with nickel by electroless plating, electrolytic plating (so-called nickel electroplating) is preferably used from the viewpoint of efficiency. In nickel electroplating, the conductive resin molded body is used as a cathode.

Nickel electroplating can be done using a known plating bath. For example, a watt bath, a chloride bath, a sulfamic acid bath, or the like can be used. Nickel electroplating can be done with a plating bath having a composition, and under conditions, for example as indicated hereinafter. An amount of plating of nickel can be adjusted by varying a conduction time in electrolytic plating.

(Bath Composition)

Salt (aqueous solution): Nickel sulfamate (350 to 450 g/L)

Boric acid: 30-40 g/L

pH: 4-4.5.

(Conditions for Electrolysis)

Temperature: 40-60° C.

Current density: 0.5 to 10 A/dm²

Anode: Insoluble anode.

The first porous body precursor having the conductive resin molded body plated with nickel can thus be obtained.

<Third Step>

In the third step, the first porous body precursor is plated with cobalt to obtain the second porous body precursor. While the first porous body precursor can be plated with cobalt by electroless plating, electrolytic plating (so-called cobalt electroplating) is preferably used from the viewpoint of efficiency. In cobalt electroplating, the first porous body precursor is used as a cathode.

Cobalt electroplating can be done using a known plating bath. For example, a watt bath, a chloride bath, a sulfamic acid bath, or the like can be used. Cobalt electroplating can be done with a plating bath having a composition, and under conditions, for example as indicated hereinafter. By performing cobalt electroplating under such conditions, plating of cobalt is formed on plating of nickel. An amount of plating of cobalt can be adjusted by varying a conduction time in electroplating. That is, a ratio in mass of cobalt to a total mass of nickel and cobalt can be adjusted by changing a conduction time in electrolysis.

(Bath Composition)

Salt (aqueous solution): Cobalt sulfamate (350 to 450 g/L)

Boric acid: 30-40 g/L

pH: 4-4.5.

(Conditions for Electrolysis)

Temperature: 40-60° C.

Current density: 0.5 to 10 A/dm²

Anode: Insoluble anode.

The second porous body precursor having a framework including nickel plating and cobalt plating can thus be obtained.

<Fourth Step>

Subsequently, the second porous body precursor is subjected to a heat treatment to incinerate a resin component in the conductive resin molded body and remove the resin component to obtain the third porous body precursor. The heat treatment for removing the resin component may be done for example at a temperature of 600° C. or higher in an atmosphere which is an oxidizing atmosphere such as air.

<Fifth Step>

The third porous body precursor thus obtained is subjected to a heat treatment in a reducing atmosphere to thermally diffuse nickel and cobalt to thus obtain a porous body. Through thermal diffusion, nickel plating and cobalt plating can form a film of a nickel-cobalt alloy which is uniform while having a prescribed surface roughness. Examples of the reducing atmosphere include H₂ gas atmosphere and CO gas atmosphere. In this embodiment, the third porous body precursor is preferably subjected to heat treatment in a H₂ gas atmosphere. While the heat treatment's temperature and time are not limited to those indicated below, they are for example 1000° C. for 3 hours or 1100° C. for 20 minutes. Thus a porous body having a framework having a three-dimensional network structure can be obtained. The framework has a surface with an arithmetic mean roughness of 0.05 μm or more.

Herein, the porous body obtained in the above method has an average pore diameter substantially equal to that of the resin molded body. Accordingly, the average pore diameter of the resin molded body used to obtain the porous body may be selected, as appropriate, depending on the application of the porous body. The porous body has a porosity ultimately determined by the amount (the apparent weight) of the plating metal. Accordingly, the apparent weight of the plating nickel and that of the plating cobalt may be selected as appropriate depending on the porosity required for the porous body as a final product. The resin molded body's porosity and average pore diameter are defined in the same manner as the above described framework's porosity and average pore diameter, and can be determined based on the above calculation formula with the term “framework” replaced with the term “resin molded body.”

Through the above steps, the porous body according to the present embodiment can be produced. That is, the porous body comprises a framework having a three-dimensional network structure, and the framework has a body including nickel and cobalt as constituent elements. Furthermore, the body of the framework includes the cobalt at a proportion in mass of 0.2 or more and 0.8 or less relative to a total mass of the nickel and the cobalt. The framework has a surface with an arithmetic mean roughness of 0.05 μm or more. The porous body is increased in volume by 1% or more for a shape of an external appearance thereof after the porous body undergoes a heat treatment in the atmosphere at 800° C. for 200 hours with a load of 16 kPa applied. Thus, the porous body can maintain satisfactory contact with a cell for a fuel cell when the porous body is used as a current collector for an air electrode or a hydrogen electrode of the fuel cell and the cell for the fuel cell is thermally deformed. Further, when the porous body is used as a current collector for an air electrode or a hydrogen electrode of a steam electrolysis apparatus, it can maintain satisfactory contact with a cell for the steam electrolysis apparatus even when the cell for the steam electrolysis apparatus is thermally deformed.

What has been described above includes features indicated in the following additional note.

(Additional Note 1)

A porous body comprising a framework having a three-dimensional network structure,

the framework having a body including nickel and cobalt as constituent elements,

the body of the framework including the cobalt at a proportion in mass of 0.2 or more and 0.8 or less relative to a total mass of the nickel and the cobalt,

the framework having a surface roughness of 0.05 μm or more,

the porous body being increased in volume by 1% or more for a shape of an external appearance thereof after the porous body undergoes a heat treatment in the atmosphere at 800° C. for 200 hours with a load of 16 kPa applied.

### Examples

Hereinafter, the present invention will more specifically be described with reference to examples although the present invention is not limited thereto.

<<Preparing the Porous Body>>

<Samples 1 to 5>

Porous bodies for Samples 1 to 5 were produced through the following procedure:

(First Step)

Initially, a 1.5 mm thick polyurethane resin sheet was prepared as a resin molded body having a three-dimensional network structure. When this polyurethane resin sheet's porosity and average pore diameter were determined based on the above formula, the porosity was 96% and the average pore diameter was 450 μm.

Subsequently, the resin molded body was impregnated with a conductive paint (slurry including carbon black), and then squeezed with a roll and dried to form a conductive coating layer on a surface of the resin molded body. A conductive resin molded body was thus obtained.

(Second Step)

Using the conductive resin molded body as a cathode, nickel electroplating was performed with a bath composition under conditions for electrolysis, as indicated below. As a result, 660 g/m² of nickel was deposited on the conductive resin molded body, and a first porous body precursor was thus obtained.

<Bath Composition>

Salt (aqueous solution): nickel sulfamate (400 g/L)

Boric acid: 35 g/L

pH: 4.5.

<Conditions for Electrolysis>

Temperature: 50° C.

Current density: 5 A/dm²

Anode: Insoluble anode.

(Third Step)

Using the first porous body precursor as a cathode, cobalt electroplating was performed with a bath composition under conditions for electrolysis, as indicated below. The second porous body precursor having a framework including nickel plating and cobalt plating was thus obtained. In order to adjust a proportion in mass of cobalt to a total mass of nickel and cobalt to be 0.9 (Sample 1), 0.8 (Sample 2), 0.6 (Sample 3), 0.3 (Sample 4), or 0.1 (Sample 5), a time for passing a current for cobalt plating was adjusted depending on the amount of plating of nickel.

<Bath Composition>

Salt (aqueous solution): cobalt sulfamate (400 g/L)

Boric acid: 35 g/L

pH: 4.5.

<Conditions for Electrolysis>

Temperature: 50° C.

Current density: 5 A/dm²

Anode: Insoluble anode.

(Fourth Step)

The second porous body precursor is subjected to a heat treatment to incinerate a resin component in the conductive resin molded body and remove the resin component to obtain the third porous body precursor. The heat treatment for removing the resin component was done for example at a temperature of 650° C. in an atmosphere of air.

(Fifth Step)

The third porous body precursor thus obtained was subjected to a heat treatment in a reducing atmosphere (H₂ gas atmosphere) to thermally diffuse nickel and cobalt to thus obtain porous bodies for samples 1 to 5. The heat treatment's temperature and time were 1000° C. and 300 minutes, respectively.

<Sample 6>

A porous body for Sample 6 was produced through the same process as Sample 1 except that for a bath composition used in the second step an aqueous solution of nickel sulfamate and cobalt sulfamate was used instead of an aqueous solution of nickel sulfamate (400 g/L) and the third step was not performed. The aqueous solution of nickel sulfamate and cobalt sulfamate included Ni and Co in an amount of 400 g/L in total with a ratio in mass of Co/(Ni+Co) set to 0.8 (80% by mass).

<Samples 7 and 8>

As Samples 7 and 8, a commercially available SUS mesh (material: SUS304, weave: plain, number of meshes: 10, wire diameter: 0.5 mm) and an SUS nonwoven fabric (material: SUS316L, weight per unit area: 120 g/m², wire diameter: 12 μm, thickness: 0.5 mm) were prepared, respectively.

<Sample 9>

A porous body for Sample 9 was produced through the same process as Sample 1 except that the third step was not performed.

<Sample 10>

A porous body for Sample 10 was produced through the same process as Sample 1 except that stannous sulfate (20 g/L) and sulfuric acid (100 g/L) were used for a bath composition used in the third step. In order to adjust a proportion in mass of tin to a total mass of nickel and tin to be 0.15, a conduction time for tin plating was adjusted depending on the amount of plating of nickel.

<Sample 11>

A porous body for Sample 11 was produced through the same process as Sample 1 except that 230 g/L of chromic acid, 5 g/L of sodium silicofluoride, and 1 g/L of sulfuric acid were used for a bath composition used in the third step. In order to adjust a proportion in mass of chromium to a total mass of nickel and chromium to be 0.3, a conduction time for chromium plating was adjusted depending on the amount of plating of nickel.

<<Evaluating Performance of Porous Body>>

<Analyzing Physical Property of Porous Body>

The porous bodies for samples 1 to 6 were each examined for a proportion in mass of cobalt in the body of the framework of the porous body relative to a total mass of nickel and cobalt in the body of the framework of the porous body with an EDX device accompanying the SEM (an SEM part: trade name “SUPRA35VP” manufactured by Carl Zeiss Microscopy Co., Ltd., and an EDX part: trade name “octane super” manufactured by AMETEK, Inc.). Specifically, initially, the porous body of each sample was cut. Subsequently, the cut porous body had its framework observed in cross section with the EDX device to detect each element, and the cobalt's proportion in mass was determined based on the element's atomic percentage. A result thereof is shown in Table 1.

Further, the above calculation formula was used to determine the average pore diameter and porosity of the framework of each of the porous bodies of Samples 2 and 6. As a result, the average pore diameter and porosity matched the resin molded body's porosity and average pore diameter, and the porosity was 96% and the average pore diameter was 450 μm. Further, the porous bodies of Samples 2 and 6 had a thickness of 1.4 mm. In each of the porous bodies of Samples 2 and 6, the total apparent weight of nickel and cobalt was 660 g/m².

<Evaluating Surface Roughness>

Samples 1 to 11 had their frameworks measured for arithmetic surface roughness (Ra) using a laser microscope VK-X1000 (manufactured by Keyence Corporation). In doing so, they were measured with a magnification of 1000 times so that at least one rib had a widthwise direction within one field of view. Further, they were measured in a range of any 20 μm-length passing through a center of the rib in the widthwise direction and being parallel to the longitudinal direction of the rib. This measurement was performed for a single porous body at at least 10 fields of view, and an average value of the obtained values was defined as an arithmetic surface roughness (Ra) of the framework of each sample. Note that arithmetic mean roughness Ra means an arithmetic mean roughness as defined in JIS B 0601 (2001). A result thereof is shown in Table 1.

<Evaluating Thickness after Heat Treatment>

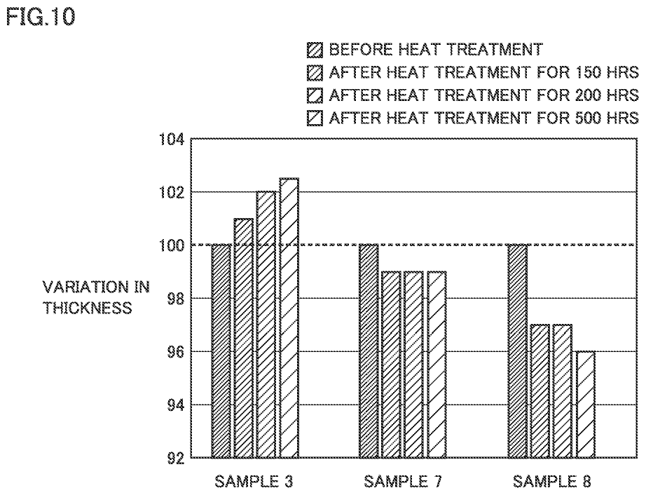

Samples 1 to 11 were evaluated in thickness after heat treatment through the following procedure. Note that samples 2 to 4 are examples, and samples 1 and 5 to 11 are comparative examples. Initially, as samples for evaluation, Samples 1 to 11 were prepared in the form of a sheet of 2.5 cm². Subsequently, an SUS block (of 1 kg) was placed on a major surface of each sample to apply a load of 16 kPa thereto. While the load was applied thereto, the sample underwent a heat treatment in the atmosphere at 800° C. for a predetermined period of time (of 150 to 1000 hours). Thereafter, the sample was measured in thickness using a digital thickness gauge to determine a rate of change with respect to the thickness before the heat treatment. A result thereof is shown in Table 1 and FIG. 10.

TABLE 1

| | | surface | rate of change in thickness | | | | maximum output | |
|---|---|---|---|---|---|---|---|---|
| | | roughness | after heat treatment (%) | | | | power retention ratio | |
| | composition | (Ra) | 150 h | 200 h | 500 h | 1000 h | (1000 h) (%) | evaluation |
| sample 1 | Ni_{0.1}Co_{0.9} | ≥0.05 μm | 3.1 | 3.6 | 3.9 | 4.2 | 77 | R |
| | (proportion in mass of Co: 0.9) | | | | | | | |
| sample 2 | Ni_{0.2}Co_{0.8} | ≥0.05 μm | 3.0 | 3.5 | 3.8 | 4.1 | 94 | A |
| | (proportion in mass of Co: 0.8) | | | | | | | |
| sample 3 | Ni_{0.4}Co_{0.6} | ≥0.05 μm | 1.0 | 2.0 | 2.5 | 2.8 | 92 | A |
| | (proportion in mass of Co: 0.6) | | | | | | | |
| sample 4 | Ni_{0.7}Co_{0.3} | ≥0.05 μm | 0.5 | 1.0 | 1.4 | 1.8 | 95 | A |
| | (proportion in mass of Co: 0.3) | | | | | | | |
| sample 5 | Ni_{0.9}Co_{0.1} | ≥0.05 μm | 0.4 | 0.8 | 1.1 | 1.4 | 74 | R |
| | (proportion in mass of Co: 0.1) | | | | | | | |
| sample 6 | Ni_{0.2}Co_{0.8} | <0.05 μm | — | 0.3 | — | — | 79 | R |
| | (proportion in mass of Co: 0.8) | | | | | | | |
| sample 7 | SUS mesh | <0.05 μm | −1 | −1 | −1 | −1 | 85 | R |
| sample 8 | SUS non-woven fabric | <0.05 μm | −3 | −3 | −4 | −4 | 79 | R |
| sample 9 | Ni | ≥0.05 μm | 0.5 | 0.7 | 1.5 | 4.2 | 52 | R |
| sample 10 | NiSn | ≥0.05 μm | 0.3 | 0.5 | 1.6 | 4.1 | 70 | R |
| sample 11 | NiCr | ≥0.05 μm | 0.2 | 0.3 | 0.4 | 0.4 | 71 | R |

A: Accepted Product
R: Rejected Product

From the result shown in Table 1 and FIG. 10, it has been found that the porous bodies of Samples 2 to 4 had a rate of change in thickness of 1% or more (and also had a rate of change in volume of 1% or more) after a prescribed heat treatment was performed for 200 hours, and that they were satisfactory porous bodies. On the other hand, the porous bodies of Samples 5 to 11 had a rate of change in thickness of less than 1% after the prescribed heat treatment was performed for 200 hours. In particular, Samples 7 and 8 had a negative rate of change in thickness after the prescribed heat treatment was performed.

<Evaluating Fuel Cells>

Further, with the porous bodies of samples 1 to 11 each used as a current collector for an air electrode, a YSZ cell manufactured by Elcogen AS (see FIG. 9) was together used to fabricate a fuel cell (see FIG. 8), which was evaluated for a maximum output power retention ratio after it was driven for 1000 hours, as follows:

Initially, before the fuel cell was driven and after the fuel cell was driven for 1000 hours (with a constant current of 0.3 A/cm²), the fuel cell was measured for a voltage value (V) with a current value (I) varied, and the fuel cell's I-V characteristic was thus obtained.

Subsequently, an output power (I×V) was plotted with respect to current value I. A point in the plot at which the output power was maximum was defined as a maximum output power. Thereafter, a maximum output power retention ratio was calculated based on an expression indicated below. A result thereof is shown in Table 1. A maximum output power retention ratio of 90% or more was defined to indicate an acceptable product (evaluation: A), and a maximum output power retention ratio of less than 90% was defined to indicate a rejected product (evaluation: R).

Maximum output power retention ratio (%)=(Maximum output power after driving for 1000 hours)/(Maximum output power before driving)×100

Although embodiments and examples of the present invention have been described as described above, it has also been planned from the beginning to appropriately combine the configurations of the above-described embodiments and examples.

The embodiments and examples disclosed herein are illustrative in any respects and should not be construed as being restrictive. The scope of the present invention is defined by the terms of the claims, rather than the above-described embodiments and examples, and is intended to include any modifications within the scope and meaning equivalent to the claims.

### REFERENCE SIGNS LIST

1 rib, 2 node, 10 frame, 11 framework body, 12 framework, 13 inner portion, 14 pore, 20 cell, 30 three-dimensional network structure, 100 cell for fuel cell, 102 air electrode, 104 intermediate layer, 106 electrolyte layer, 108 hydrogen electrode, 110 current collector for hydrogen electrode, 112 first interconnector, 114 fuel channel, 120 current collector for air electrode, 122 second interconnector, 124 oxidant channel, 150 fuel cell, 200 cell for steam electrolysis apparatus, 202 air electrode, 204 intermediate layer, 206 electrolyte layer, 208 hydrogen electrode, 210 current collector for hydrogen electrode, 212 first interconnector, 214 hydrogen channel, 220 current collector for air electrode, 222 second interconnector, 224 steam channel, 250 steam electrolysis apparatus, A virtual plane.

1. A porous body comprising a framework having a three-dimensional network structure,
the framework having a body including nickel and cobalt as constituent elements,
the body of the framework including the cobalt at a proportion in mass of 0.2 or more and 0.8 or less relative to a total mass of the nickel and the cobalt,
the framework having a surface with an arithmetic mean roughness of 0.05 μm or more,
the porous body being increased in volume by 1% or more for a shape of an external appearance thereof after the porous body undergoes a heat treatment in the atmosphere at 800° C. for 200 hours with a load of 16 kPa applied.

2. The porous body according to claim 1, wherein the body of the framework further includes oxygen as a constituent element.

3. The porous body according to claim 2, wherein the oxygen is included in the body of the framework in an amount of 0.1% by mass or more and 35% by mass or less.

4. The porous body according to claim 2, wherein the body of the framework includes a spinel-type oxide.

5. The porous body according to claim 1, wherein when the body of the framework is observed in cross section at a magnification of 3,000 times to obtain an observed image the observed image presents in any area 10 μm square thereof five or less voids each having a longer diameter of 1 μm or more.

6. The porous body according to claim 1, wherein the framework is hollow.

7. The porous body according to claim 1, having a sheet-shaped external appearance and a thickness of 0.2 mm or more and 2 mm or less.

8. A fuel cell comprising a current collector for an air electrode and a current collector for a hydrogen electrode, at least one of the current collector for the air electrode or the current collector for the hydrogen electrode including the porous body according to claim 1.

9. A steam electrolysis apparatus comprising a current collector for an air electrode and a current collector for a hydrogen electrode, at least one of the current collector for the air electrode or the current collector for the hydrogen electrode including the porous body according to claim 1.
